(19) United States
(12) Patent Application Publication
(10) Pub. No.: US 2006/0276078 A1
(43) Pub. Date: Dec. 7, 2006

(54) Telecommunication terminal block system

(76) Inventors: Rick Garrett, Greenacres, WA (US); Brian Allen, Spokane Vly, WA (US)

Correspondence Address: LEE & HAYES, PLLC, 421 W. RIVERSIDE AVE, STE 500, SPOKANE, WA, 99201, US

(21) Appl. No.: 11/145,569

(22) Filed: Jun. 2, 2005

(51) Int. Cl. H01R 13/73

(52) U.S. Cl. 439/571; 439/719; 439/713

(57) ABSTRACT

A telecommunication terminal block system for telecommunications equipment, and more particularly in certain of its embodiments, to such a system for high speed Digital Subscriber Lines (“DSL”) services for use in a telecommunications facility.

### TECHNICAL FIELD

This invention pertains to a telecommunication terminal block system for telecommunications equipment, and more particularly in certain of its embodiments, to such a system for high speed Digital Subscriber Lines (“DSL”) services for use in a telecommunications facility.

### BACKGROUND OF THE INVENTION

Terminal blocks have generally been used in the telecommunications industry to interconnect wires, conductors or telecommunications devices to telecommunication lines. An overriding consideration in most if not all telecommunication facilities is the density or the number of terminal blocks and connections within the smallest practicable space, and terminal blocks help toward that aim.

Improvements to existing plain old telephone service lines such as provided by this invention may increase the capacity of current installations and facilities, and are an alternative to replacing system infrastructure to fiber optic for example.

It is therefore an object of embodiments of this invention to provide an improved terminal block system for high speed DSL services for use in a telecommunications facility.

The above needs are fulfilled as will be understood from the following description which, taken with the accompanying drawings and appended claims, describe the best mode currently known for carrying out the present invention.

### BRIEF DESCRIPTION OF THE DRAWINGS

Preferred embodiments of the invention are described below with reference to the following accompanying drawings.

FIG. 1 is a front perspective view of one embodiment of a terminal block system contemplated by this invention;

FIG. 2 is a rear perspective view of the embodiment of the invention illustrated in FIG. 1;

FIG. 3 is an exemplary front view of a terminal field configuration which may be utilized in embodiments of the invention;

FIG. 4 is an exemplary rear panel wire pin configuration which may be utilized in embodiments of the invention;

FIG. 5 is a side partial-cutaway view of a terminal block system which may be utilized in embodiments of this invention, schematically showing possible wiring connections;

FIG. 6 is the detail from FIG. 5;

FIG. 7 is one alternative bottom view of the embodiment of the invention shown in FIG. 5, illustrating one connector configuration;

FIG. 8 is another alternative bottom view of the embodiment of the invention shown in FIG. 5, illustrating a different connector configuration;

FIG. 9 is a front view of one of the connectors that may be utilized in embodiments of this invention;

FIG. 10 is a top view of an exemplary connector and wiring twisting pattern which may be utilized in embodiments of this invention;

FIG. 11 is a front view of one of the connectors that may be utilized in embodiments of this invention, a sixty-four pin connector; and

FIG. 12 is a front view of another one of the connectors that may be utilized in embodiments of this invention, a fifty pin connector.

### DETAILED DESCRIPTION OF THE PREFERRED EMBODIMENTS

Fasteners, materials, drive mechanisms, control circuitry, manufacturing and other means and components utilized to make and implement this invention are known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

The phrase terminal block as used herein is one of several terms the industry has used to refer to the terminal block systems contemplated by this invention, and other terms or phrases have also been used, terms such as: connecting blocks, cross-connect blocks, quick-connect blocks, spin down blocks, wire wrap blocks, MDF (Main Distribution Frame) blocks and/or punch-down blocks.

A Digital Subscriber Line or “DSL” line is generally a high speed type of connection that is typically used for connecting users to the world wide web or internet. The connection is generally made over traditional telephone lines or conductors and may provide connections without disturbing a user's normal telephone service. The wide spread popularity of the internet has created a very high demand on telecommunications facilities to better facilitate these types of connections.

Category 5 (“Cat5”) is an industry description of telecommunications network cabling, that may consist for instance of four twisted pairs of copper wire, although it may not be limited to such description.

An Asymmetric digital subscriber line (“ADSL”) is a type of high speed broadband internet access which is a variation of the DSL technology, wherein the “asymmetric” or “asynchronous” means that the downstream speed is different from the upstream speed, which are generally known in the industy. ADSL2 and ADSL2+ are variations from, or later generations of, the same theme, with higher speeds. The ADSL2+ may use the same copper phone lines, but transfer data faster and further than standard ADSL. The download speeds for ADSL for instance may range from 256 to 1500 kBps, with upload speeds at 64 to 256 kBps (depending on the distance from the exchange). Bps is “bits per second”, is a common measure of data speed for the transmission of data, and refers to a number of energy pulses passing a given point through a transmission medium within one second. ADSL2+ may on the other hand provide download speeds up to 12 Mbps to 24 Mbps.

An Insulation Displacement Connection (“IDC”) is a wiring scheme used in terminal blocks where the wire is punched down to the double metal holders. IDC may be utilized in this invention, although this invention is not limited to it.

Terminal blocks such as contemplated by this invention generally include a forward facing front panel containing an array or wire wrap interconnection pins and an array of jacks coupled to respective interconnection pins and operative for patching or testing of telecommunication interconnects. Multiple pin connectors are mounted on the rear panel of the block and are internally connected to respective pins on the front panel. The housing of the terminal blocks is constructed to provide access to the internal wiring without impairing the cross-connecting wiring from the terminal field to the telecommunications wires.

This invention provides embodiments of a terminal block system which accommodates performance specifications such as High Speed (“HS”) and High Speed Plus (“HS+”).

The improved electrical characteristics provided by embodiments of this invention may allow DSL signals to be effectively transmitted deeper into networks or neighborhoods, to allow service providers to provide DSL services to more households without the requirement for substantial new infrastructure.

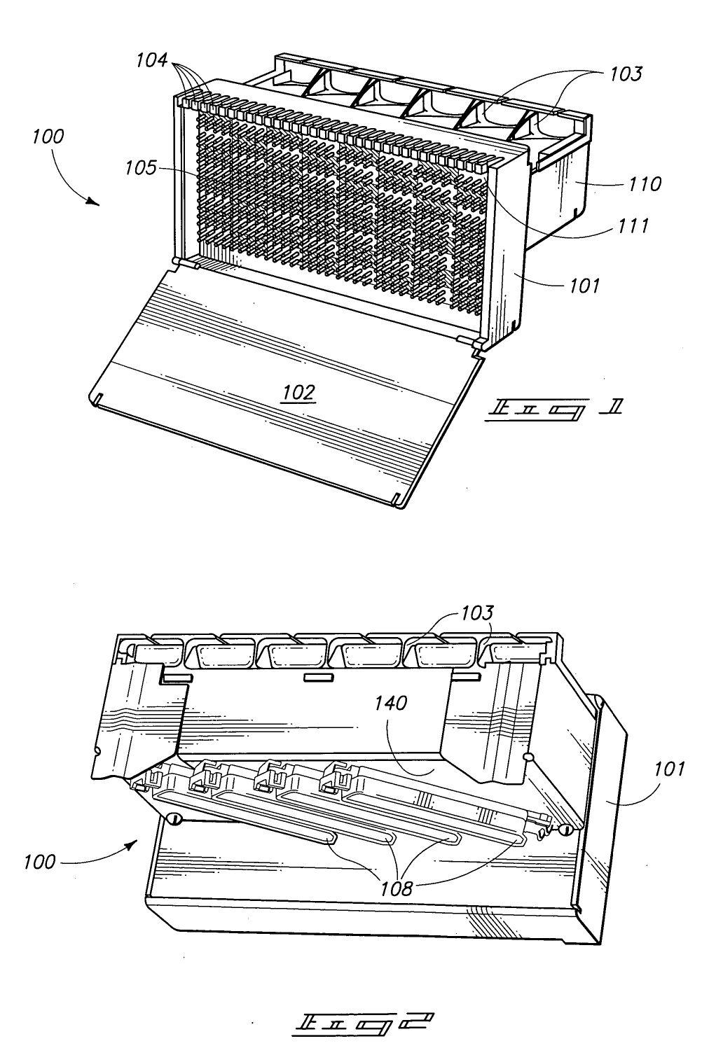

FIG. 1 is a front perspective view of one embodiment of a terminal block system contemplated by this invention, illustrating terminal block 100, first housing section 101 and second housing section 110, cover 102 pivotally attached to first housing section 101, terminal pins 105, front fanning strips 104, and rear fanning strips 103. The plurality of terminal pins 105 is provided in an array and are configured to receive wire wrap connections, which may be accomplished by any one of a number of different ways, all within the contemplation of this invention.

The front fanning strips 104 define a plurality of wire channels, passageways, openings or conduits through which wires connected to terminal pins 105 may be routed and managed. Similarly, rear fanning strips 103 provide a plurality of wire channels, passageways, openings or conduits between the fanning strips 103, through which wires may be routed and managed. It will be appreciated by those of ordinary skill in the art that no single wire management system or device is necessary to practice this invention, but instead any one of a number of such devices or systems may be utilized within the contemplation of this invention, or none may be utilized.

It will also be appreciated that while a terminal field of a certain configuration is shown in FIG. 1, with a specific number of rows and columns of terminal pins, no one particular configuration or array is required to practice this invention.

The terminal pins 105 which may be utilized in embodiments of this invention may be any one of a number of different types, shapes, and configurations, and may be made out of any one of a number of different types of materials, with no one in particular being required to practice this invention. The terminal pins 105 may be configured and disposed within the terminal field defined by an insulative panel 111 which has openings in which the terminal pins 105 are disposed and secured. The terminal pins 105 may include an external forward facing portion 105a and an internal rearward facing portion 105b (as shown more fully in FIG. 5), and are typically carried by the terminal field as single post wire wrapped terminals. Various wire wrap techniques, devices and practices are utilized in the industry, with no one in particular required to practice the invention.

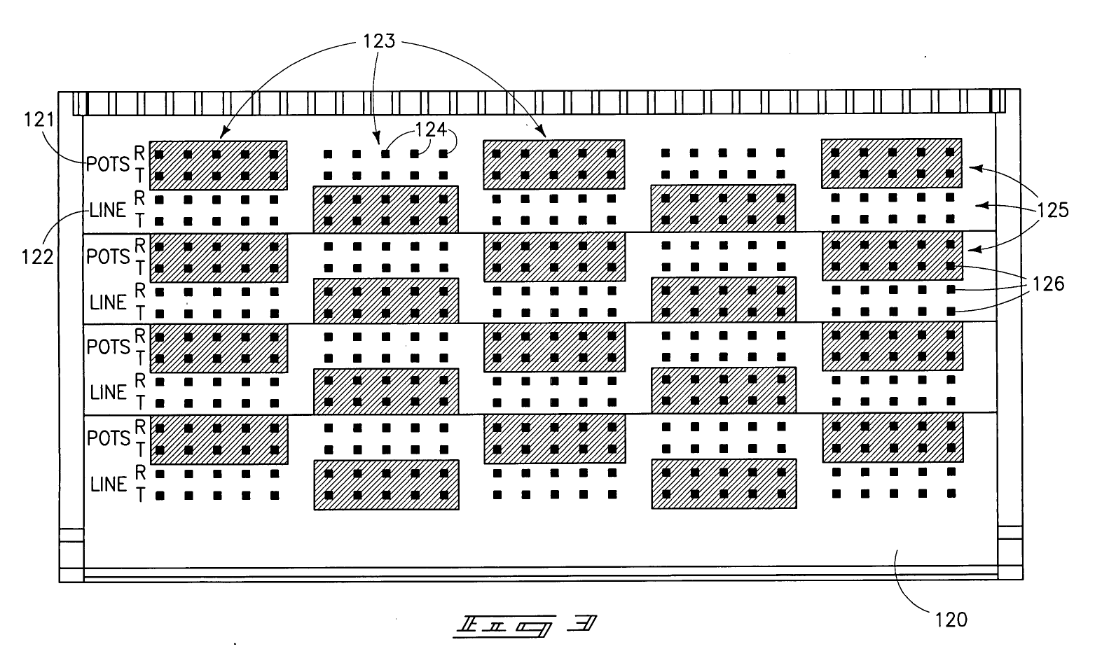

FIG. 2 is a rear perspective view of the embodiment of a terminal block system 100 contemplated by this invention illustrated in FIG. 1, illustrating first housing section 101, second housing section 110, rear fanning strips 103, and a plurality of connectors 108 configured in panel 140.

FIG. 3 is an exemplary front panel wire pin configuration or pattern which may be utilized in embodiments of the invention. FIG. 3 illustrates column groupings 123 of individual columns 124 representing groupings of terminal pins, row groupings 125 with individual rows 126. FIG. 3 also shows Plain Old Telephone Service (“POTS”) 121 designations for rows as indicated, as are other lines 122, for respective connections and identification of connections.

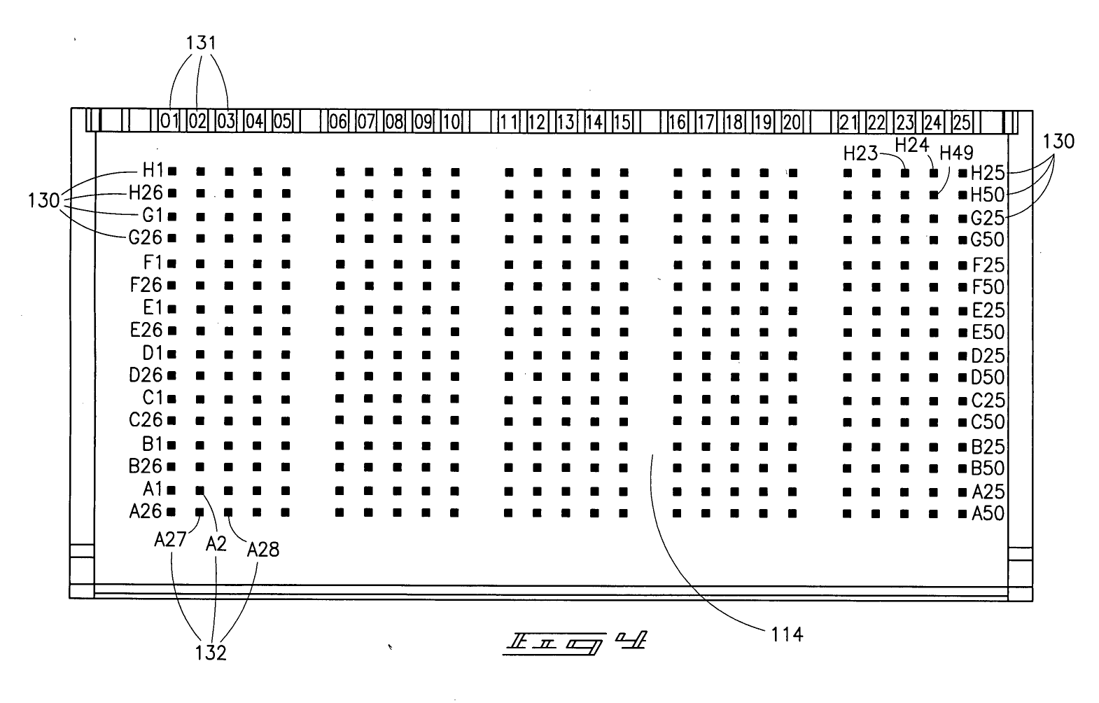

FIG. 4 is an exemplary rear panel wire pin configuration or configuration which may be utilized in embodiments of the invention, showing wire passageways 131 which may be numbered for ease of use. FIG. 4 also illustrates rows 130 with various designations or number, and columns 132 indicating a possible configuration for the rearward facing terminal pins on the rearward facing panel 114.

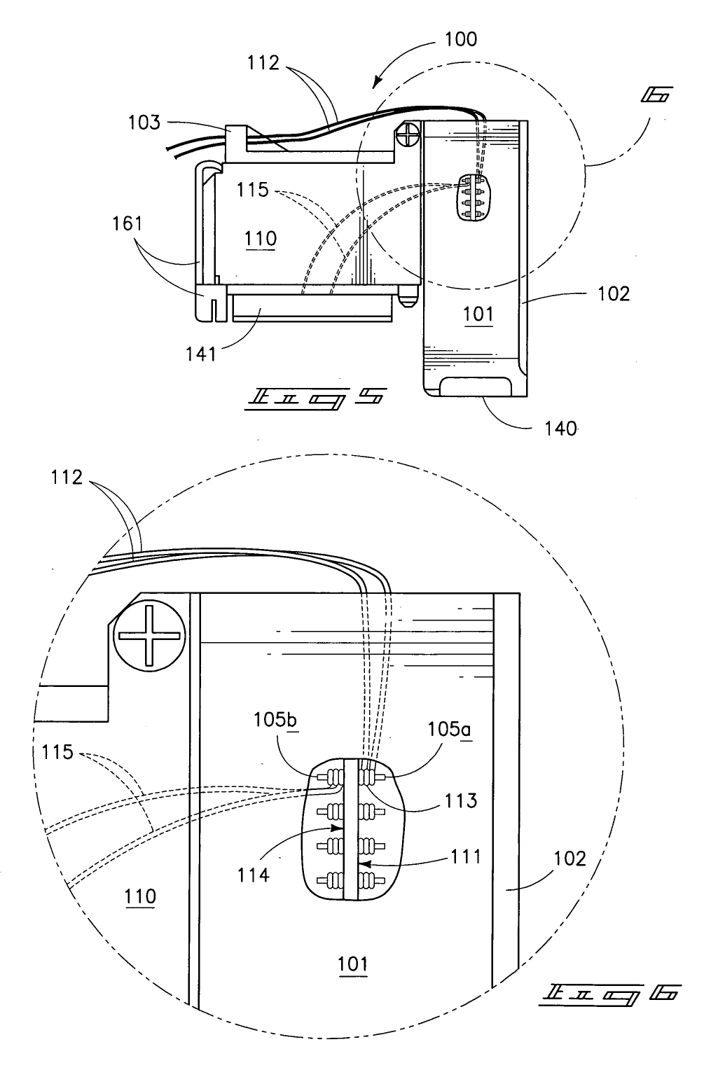

FIG. 5 is a side partial-cutaway view of a terminal block system 100 which may be utilized in embodiments of this invention, schematically showing possible wiring connections. FIG. 6 is the detail from FIG. 5, showing more detail of the terminal pins as described below. FIG. 5 illustrates cover 102, first body section 101, second body section 110, connectors 141, rear fanning strips 103.

The terminal pins 105 may be configured and disposed within the terminal field defined by an insulative panel 111 which has openings in which the terminal pins 105 are disposed and secured. The terminal pins 105 may include an external forward facing portion 105a and an internal rearward facing portion 105b (protruding from the rearward facing panel portion 114), as shown more fully in FIG. 6. Wires 112, or conductors, may be wrapped around or conductively connected to terminal pins 105 by any one of a number of different methods, devices and configurations, with no one in particular being required to practice this invention.

Wires 115 are schematically shown in dashed lines to represent an electrical connection between the rearward facing portion 105b of terminal pins 105 to connectors 141. FIG. 5 further illustrates an exemplary mounting bracket 161 that may be utilized to mount embodiments of this invention to whatever it will be mounted to, examples of which may be a Main Distribution Frame (“MDF”), relay racks, or any one of a number of other locations, all within the scope and contemplation of this invention and with no one in particular be required to practice this invention.

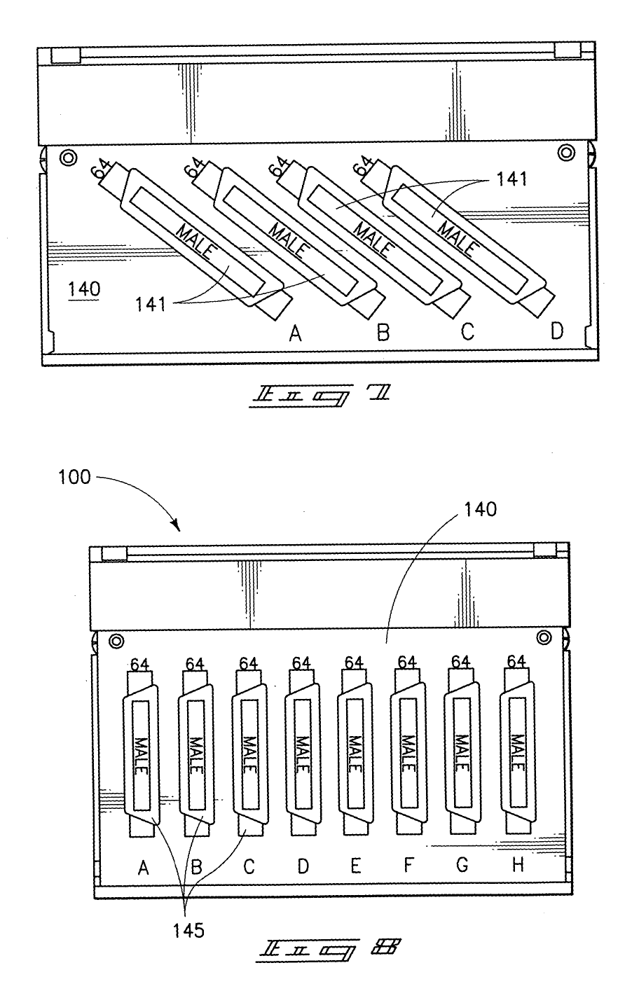

FIG. 7 is one alternative bottom view of the embodiment of the invention shown in FIG. 5, illustrating one connector field configuration with a plurality of connectors 141 disposed and secured on connector field panel 140. The connectors 141 may be provided as one or more connectors of any one of a different type of connector, or a combination of different types of connectors, depending on the specific application, all within the contemplation of this invention, with no one number, type or configuration being required to practice this invention.

The connectors 141 shown are four diagonally oriented or configured 64 pin Category 5 (“Cat5”) connectors, labeled A, B, C and D for user convenience. Any one of a number of different types of connectors may be used, such as twenty-four pin, fifty pin and sixty-four pin connectors, male connectors, female connectors, with no one in particular being required to practice this invention.

FIG. 8 is another alternative bottom view of the embodiment of the terminal block system 100 invention partially shown in FIG. 5, illustrating a different connector configuration, with eight connectors 145 shown on connector field panel, eight sixty-four pin male connectors, labeled A, B, C, D, E, F, G and H for user convenience.

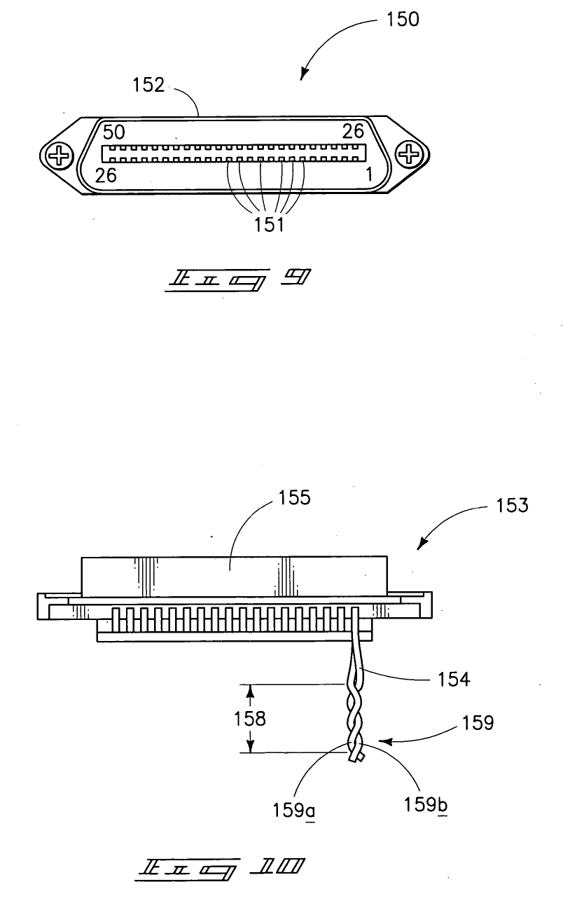

FIG. 9 is a front view of one example of a connector 150 which may be utilized in embodiments of this invention, which shows fifty pins 151 and pin identifier labels 1, 26 and 50 shown thereon for user convenience. Again, any one of a number of different types of connectors and combinations of connectors may be utilized in embodiments of this invention, with no one connector or combination of connectors being required to practice this invention. The fifty pin connector 150 in connector housing 152 shown in FIG. 9 is a fifty pin male connector.

FIG. 10 is a top view of an exemplary connector 153, connector housing 155, and wire twist pattern 154, which may be utilized in embodiments of this invention. Distance 158 represents a distance of wire and wire twist pattern 159 represents one twist of wire as that term is used by those of ordinary skill in the art. A preferred wire twist pattern which may be utilized in embodiments of this invention, is a one twist per one-half inch of wire, as shown in FIG. 10 (not to scale, but representatively). The wire twist pattern 154 may be utilized for improved electrical characteristics for terminal blocks utilized for DSL applications or embodiments, such as on the wires 115 schematically represented in FIG. 5. Old style terminal block wire twistings only required one twist every three to four inches, whereas embodiments of this invention contemplate one twist per one-half inch of wire.

There are numerous new twist ratios per length of wire contemplated by various embodiments of the invention, with no one in particular on the new ratios being required to practice this invention. For instance in the preferred embodiment, there is at least one twist 159 for each one-half of an inch of wire length 158. However, this invention contemplate other ratios, such as at least one twist 159 for each one inch of wire length 158; and at least one twist 159 for each three-quarters of an inch of wire length 158, to name only two, depending on the application. In other embodiments of this invention, there may be five twists per one inch, all within the contemplation of this invention.

Category 5 or “CAT5” wire is telephone wire or conductor, and better telephone wire utilizes internal wiring that includes “twisted pairs” of wire, which is two wires that are twisted or wrapped around one another. Wires are twisted or wrapped because each are exposed to the same magnetic filed as they revolve around each other so that electro magnetic interferences are reduced or cancelled out, and/or for other electrical characteristics and effects.

Embodiments of High Speed or “HS” terminal block systems may utilize standard telco or industry pin out or connector configurations, whereas HS+ embodiments may utilize Category 5 pin-outs, although this invention is not so limited.

Embodiments of this invention may utilize standard telephone company or telco wiring, instead of specialized and more expensive custom cabling required in other applications.

It will be appreciated by those of ordinary skill in the art that embodiments of this invention may reduce insertion loss, crosstalk and return loss, which may facilitate the elimination of a limitation present in many telecommunication systems today.

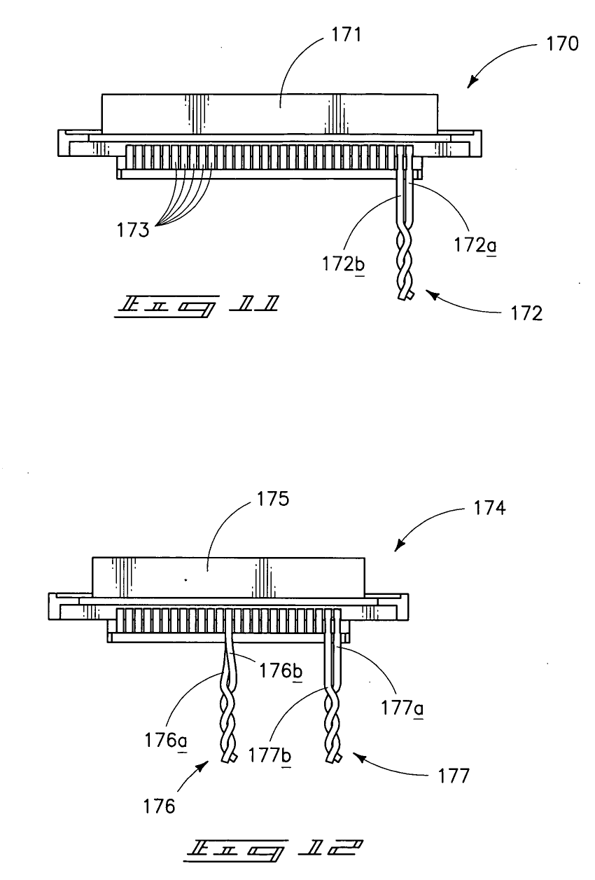

FIG. 11 is a front view of another one of the connectors 170 that may be utilized in embodiments of this invention, a sixty-four pin connector, with connector housing 171, connector pins 173, a twisted pair 172 of conductors or wires, namely a first conductor 172a and a second conductor 172b. The twisting ratios and relative to distances for FIG. 11 are the same as described above for FIG. 10.

FIG. 12 is a front view of another one of the connectors 174 that may be utilized in embodiments of this invention, a fifty pin connector, with connector housing 175. FIG. 12 shows an embodiment of the invention which utilizes a fifty pin connector, wherein pins thirteen and thirty-eight (which one of ordinary skill in the art would recognize to be pair number 7), are wired across the connector providing similar electrical characteristics. A first conductor 176a and a second conductor 176b comprise the first twisted pair 176 shown, and a first conductor 177a and a second conductor 177b comprise the second twisted pair 177 shown in FIG. 12. The twisting ratios and relative to distances for FIG. 12 are the same as described above for FIG. 10.

As will be appreciated by those of reasonable skill in the art, there are numerous embodiments to this invention, and variations of elements and components which may be used, all within the scope of this invention.

In one embodiment for example, a terminal block system for use in telecommunications, comprising: a terminal block housing; a plurality of terminal pins secured in an insulative terminal panel, said plurality of terminal pins including a forward facing portion extending from a forward side of the insulative terminal panel and a rearward facing portion extending from a reward side of the insulative panel; a plurality of high speed connectors mounted relative to the terminal block housing; and at least one pair of twisted conductors electrically connected at a first end to terminal pins in the plurality of terminal pins, electrically connected at a second end to at least one of the plurality of high speed connectors, and configured for at least high speed transmission.

In further embodiments of the foregoing, a terminal block system may further be provided wherein a first conductor of the at least one pair of twisted conductors is twisted relative to a second conductor of the at least one pair of twisted conductors, at twist rates of: at least one twist per one and one-half inches of the second conductor; at least one twist per one inch of the second conductor; at least one twist per three-quarters of an inch of the second conductor; or at least one twist per one-half inch of the second conductor; to name a few within the contemplation of this invention.

Other embodiments of this invention may be wherein the terminal block housing is further comprised of a first housing section and a second housing section; wherein at least one of the plurality of high speed connectors is a category 5 connector; and/or further wherein the at least one pair of twisted conductors electrically connected at a first end to terminal pins in the plurality of terminal pins, is electrically connected at a second end to at least one of the plurality of high speed connectors, and configured for at least high speed transmission plus.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

I claim:

1. A terminal block system for use in telecommunications, comprising:
a terminal block housing;
a plurality of terminal pins secured in an insulative terminal panel, said plurality of terminal pins including a forward facing portion extending from a forward side of the insulative terminal panel and a rearward facing portion extending from a reward side of the insulative panel;
a plurality of high speed connectors mounted relative to the terminal block housing; and
at least one pair of twisted conductors electrically connected at a first end to terminal pins in the plurality of terminal pins, electrically connected at a second end to at least one of the plurality of high speed connectors, and configured for at least high speed transmission.

2. A terminal block system as recited in claim 1, and further wherein a first conductor of the at least one pair of twisted conductors is twisted relative to a second conductor of the at least one pair of twisted conductors, at a twist rate of at least one twist per one and one-half inches of the second conductor.

3. A terminal block system as recited in claim 1, and further wherein a first conductor of the at least one pair of twisted conductors is twisted relative to a second conductor of the at least one pair of twisted conductors, at a twist rate of at least one twist per one inch of the second conductor.

4. A terminal block system as recited in claim 1, and further wherein a first conductor of the at least one pair of twisted conductors is twisted relative to a second conductor of the at least one pair of twisted conductors, at a twist rate of at least one twist per three-quarters of an inch of the second conductor.

5. A terminal block system as recited in claim 1, and further wherein a first conductor of the at least one pair of twisted conductors is twisted relative to a second conductor of the at least one pair of twisted conductors, at a twist rate of at least one twist per one-half inch of the second conductor.

6. A terminal block system as recited in claim 1, and further wherein a first conductor of the at least one pair of twisted conductors is twisted relative to a second conductor of the at least one pair of twisted conductors, at a twist rate of at least five twists per inch of the second conductor.

7. A terminal block system as recited in claim 1, and further wherein the terminal block housing is further comprised of a first housing section and a second housing section.

8. A terminal block system as recited in claim 1, and further wherein at least one of the plurality of high speed connectors is a category 5 connector.

9. A terminal block system as recited in claim 1, and further wherein the at least one pair of twisted conductors electrically connected at a first end to terminal pins in the plurality of terminal pins, is electrically connected at a second end to at least one of the plurality of high speed connectors, and configured for at least high speed transmission plus.

10. A terminal block system for use in telecommunications, comprising:
a terminal block housing;
a plurality of terminal pins secured in an insulative terminal panel, said plurality of terminal pins including a forward facing portion extending from a forward side of the insulative terminal panel and a rearward facing portion extending from a reward side of the insulative panel; and
a plurality of high speed DSL connectors mounted relative to the terminal block housing.

11. A terminal block system as recited in claim 10, and further comprising: at least one pair of twisted conductors electrically connected at a first end to terminal pins in the plurality of terminal pins, electrically connected at a second end to at least one of the plurality of high speed connectors, and configured for at least high speed transmission.

12. A terminal block system as recited in claim 11, and further wherein a first conductor of the at least one pair of twisted conductors is twisted relative to a second conductor of the at least one pair of twisted conductors, at a twist rate of at least one twist per one and one-half inches of the second conductor.

13. A terminal block system as recited in claim 11, and further wherein a first conductor of the at least one pair of twisted conductors is twisted relative to a second conductor of the at least one pair of twisted conductors, at a twist rate of at least one twist per one inch of the second conductor.

14. A terminal block system as recited in claim 11, and further wherein a first conductor of the at least one pair of twisted conductors is twisted relative to a second conductor of the at least one pair of twisted conductors, at a twist rate of at least one twist per three-quarters of an inch of the second conductor.

15. A terminal block system as recited in claim 11, and further wherein a first conductor of the at least one pair of twisted conductors is twisted relative to a second conductor of the at least one pair of twisted conductors, at a twist rate of at least one twist per one-half inch of the second conductor.

16. A terminal block system as recited in claim 11, and further wherein a first conductor of the at least one pair of twisted conductors is twisted relative to a second conductor of the at least one pair of twisted conductors, at a twist rate of at least five twists per inch of the second conductor.

17. A terminal block system as recited in claim 11, and further wherein the terminal block housing is further comprised of a first housing section and a second housing section.

18. A terminal block system as recited in claim 11, and further wherein at least one of the plurality of high speed connectors is a category 5 connector.

19. A terminal block system as recited in claim 11, and further wherein the at least one pair of twisted conductors electrically connected at a first end to terminal pins in the plurality of terminal pins, is electrically connected at a second end to at least one of the plurality of high speed connectors, and configured for at least high speed transmission plus.
